(19) United States
(12) Patent Application Publication
(10) Pub. No.: US 2006/0186162 A1
(43) Pub. Date: Aug. 24, 2006

(54) Motorcycle tie-down system

(76) Inventor: Kent A. Stubbs, Red Bluff, CA (US)

Correspondence Address: WILLIAM S. BERNHEIM, 255 N. LINCOLN ST, DIXON, CA, 95620, US

(21) Appl. No.: 11/062,794

(22) Filed: Feb. 23, 2005

(51) Int. Cl. B60R 11/00; B60P 3/06

(52) U.S. Cl. 224/572; 410/3

(57) ABSTRACT

A strapping system for positioning and transporting a motorcycle in an upright position including two interconnected straps with cylindrical cuffs closed on one end so as to preclude sliding of the cuffs while engaging the grips of the handle bar.

### CROSS REFERENCE TO RELATED APPLICATIONS

Original Patent Application Stubbs U.S. Pat. No. 5,326,202 Tie Down System For Motorcycles.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to a strapping system for securing motorcycle in an upright position for transport.

2. Description of the Related Art

Motorcycles are two wheel vehicles that vary in size and shape depending on the model. However, there is general similarity in the shape of motorcycles, which allows the present invention to be applicable to different models of motorcycles and other vehicles of similar shape.

During transport of a motorcycle the forces incurred vary greatly, both in severity and direction, depending upon various factors. These include road conditions, driving habits, construction and condition of the vehicle used for transport, and the users understanding of the various methods of securing a motorcycle for transport.

One of the present strapping systems include tying a motorcycle down with two separate ropes, one from each handle bar, which cause excessive wearing of motorcycle parts such as handle bar covering and gas tank paint. This method is also inherently difficult as it requires balancing the tension equally on the different tie downs.

Another strapping system includes two interconnected straps with soft cuffs engaging the grips of the handle bar. This method reduces the damage to the handle bar covering and gas tank paint. However, the soft cuff design of the system allows handlebar grips to be exposed to a lateral pull that sometimes resulted in an inward “bunching” of the grips if the grips are not sufficiently glued to the throttle tube (on the right side) and handlebar (on the left side). In addition, under certain conditions this strapping system would contact with switch gear (horn, turn signal, and start buttons) causing unnecessary wearing of motorcycle parts.

The new improved motorcycle tie down system and method for transport of motorcycles provides solutions to these problems inherent in the related art.

### BRIEF SUMMARY OF THE INVENTION

The present invention provides a new and improved strapping system for securing motorcycles for transport in a vertical upright position, which also reduces damage during the transport and provides greater motorcycle stability. The present invention overcomes certain undesirable properties inherent in the related art, while providing better overall results.

### DETAILED DESCRIPTION OF THE INVENTION

The invention comprises two identical securing straps that have a cuff on one end and a securing means (hereinafter defined as a hook, shackle, or other device useful for attaching strap 11 to a floor, ring, other connector or aperture) on the other end. Two straps are interconnected in such a way that they represent mirror image of one another.

This invention uses a molded cuff (rather than a soft cuff sewn from fabric as in known designs). The molded cuff incorporates a closed end which acts as a “stop” to prevent the cuff from migrating inward under tension and either “bunching” the grips or contacting any switchgear.

Each of the securing straps is attached to a slot molded into the cuff and pass through the slot molded into the opposing cuff.

The latest technologies in plastics are being incorporated in the design of molded cuffs to ensure resistance to breakage, distortion, and UV degradation to improve the quality of service and extend the service life of this securing strap system.

### BRIEF DESCRIPTION OF THE SEVERAL VIEWS OF THE DRAWINGS

The invention is illustrated in the following drawings:

FIG. 1 schematically shows the motorcycle tie-down system of the present invention attached to a motorcycle.

FIG. 2 is a schematic view of the motorcycle tie-down system of the present invention.

FIG. 3 is a schematic view of a grip cuff incorporated into the motorcycle tie-down system of the present invention.

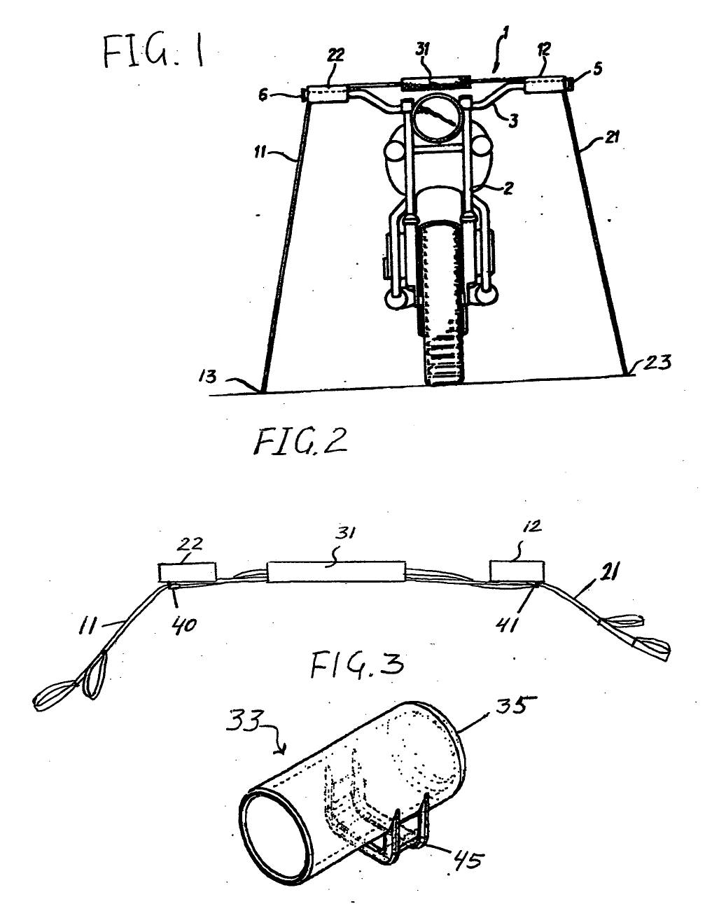

In FIG. 1, a strapping system in accordance with present invention is shown attached to motorcycle 2. The strapping system includes a first securing strap 11 having at one end securing means 13 (as defined hereinabove) and at the second end first grip cuff 12.

The first securing strap 11 is interconnected with identical second securing strap 21. Second securing strap 21 has at one end a securing means 23 identical to securing means 13, and at its second end second grip cuff 22. First securing strap 11 is passed through the slot molded into second grip cuff 22 and second securing strap 21 is passed through the slot molded into first grip cuff 12 so that the two straps are permanently interconnected.

The first grip cuff 12 has been slipped onto the left grip bar 5 and the first securing strap 11 extends across the center of the motorcycle to pass through the slot molded into the second grip cuff 22. Then, first securing strap 11 is secured to the surface of the transport vehicle or trailer via securing means 13.

Similarly second grip cuff 22 has been slipped onto the right grip bar 6 and second securing strap 21 extends across the center of the motorcycle to pass through the slot molded into first grip cuff 12, which has been slipped over the left grip. Then, second securing strap 21 is secured to the surface of the transport vehicle or trailer via securing means 23.

Padded anti-chaffing bumper 31 made from the soft material is positioned between the two grip cuffs and cylindrically encloses a portion of the first and second securing straps. Anti-chaffing bumper 31 is a padded tube and not essential for operation of the invention but provides protection against chaffing damage if the straps 11 and 21 contact the motorcycle parts between the left and the right grip.

FIG. 2 represents a schematic view of the present invention. The securing straps 11 and 21 can be fashioned from commercial grade rigging straps, which come in different strength. These straps are typically ¾ inches in width by 1/10 inch in depth, and about 40 inches in overall length.

The grip cuffs 12 and 22 are made from a hard material, such as breakage resistant plastic or similar material. First securing strap 11 is fixedly attached to the pin formed by molded slot 41 of first grip cuff 12 and is passed through the molded slot 40 of second grip cuff 22 in such a way that it may slide therein. Likewise, second securing strap 21 is connected to the pin formed by molded slot 40 on second grip cuff 22 and is similarly passed through molded slot 41 on the first grip cuff 12.

As better seen in FIG. 3, the grip cuff 33 (representing grip cuffs 12 and 22) is cylindrical in shape with closed end 35, and open end 36 so that it may fit onto the handle bars. The molded slot 45 (representing molded slots 40, 41) is positioned inward from open end 36 of the cuff so that it allows the stress points to be on the bar rather than on the bar-end weights since the weights are seldom capable of withstanding the forces generated in tying down a motorcycle. The molded slots 45, 40 and 41 create an opening for securing straps 11 and 21 to pass through the grip cuffs close to the handle bar, which closeness is important for fairing clearance.

The above description presents the best mode contemplated in carrying out my invention. However, it is susceptible to modifications and alternate constructions from the embodiments shown in the drawings and accompanying description. Consequently it is not intended that the invention be limited to the particular embodiments disclosed. On the contrary, the invention is intended to cover all modifications, sizes and alternate constructions falling within the spirit and scope of the invention, as expressing in the appended claims or the equivalents thereof.

I claim:

1. An apparatus for securing a motorcycle in an upright position during transport comprising:
a. a first securing strap having at a first end a first grip cuff and at a second end a first securing means with which to secure the motorcycle to a transport vehicle;
b. a second securing strap interconnected with the first securing strap, the second securing strap having at a first end a second grip cuff and at a second end a second securing means,
c. the first and the second grip cuffs exhibiting a cylinder open at one end sufficiently so as to receive at least a portion of a handle bar of the motorcycle and sufficiently obstructed at the cylinder's other end so as to prohibit passage of the handle bar; and
d. the first securing strap interconnected with the second securing strap by way of the first securing strap passing through an aperture of the second grip cuff and the second securing strap passing through a aperture of the first grip cuff.

2. The apparatus of claim 1 wherein a padding tube extends along and cylindrically encloses a portion of the first securing strap adjacent the first grip cuff and extends along and cylindrically encloses a portion of the second securing strap adjacent the second grip cuff.
